(19) United States
(12) Patent Application Publication
(10) Pub. No.: US 2020/0027032 A1
(43) Pub. Date: Jan. 23, 2020

(54) REDUCING COMPUTATIONAL COSTS TO PERFORM MACHINE LEARNING TASKS

(71) Applicant: INTERNATIONAL BUSINESS MACHINES CORPORATION, Armonk, NY (US)

(72) Inventors: Tetsuro Morimura, Tokyo (JP); Michiko Okudo, Tokyo (JP); Takayuki Katsuki, Tokyo (JP)

(21) Appl. No.: 16/039,700

(22) Filed: Jul. 19, 2018

(51) Int. Cl. G06N 99/00; G06N 7/08

(52) U.S. Cl. CPC G06N 99/005; G06N 7/08

(57) ABSTRACT

A computer-implemented method for reducing computational costs for reducing computational costs to perform machine learning tasks includes generating one or more state partitioning candidates corresponding to a plurality of states associated with a partially observable Markov decision process (POMDP) model, determining that a given state partitioning candidate of the one or more state partitioning candidates satisfies a merge condition based on a state transition matrix for the given state partitioning candidate, and performing a machine learning task based on the POMDP model with merged states using the given state partitioning candidate.

### BACKGROUND

### Technical Field

The present invention generally relates to machine learning, and more particularly to reducing computational costs to perform machine learning tasks.

### Description of the Related Art

Decision process models can be used to study a wide range of optimizations problems that can be solved using machine learning. One example of a machine learning task is a reinforcement learning task. The goal of reinforcement learning is to train an artificial intelligence agent to select reward maximizing or cost minimizing actions by associating actions with rewards or costs.

### SUMMARY

In accordance with an embodiment of the present invention, a method for reducing computational costs to perform machine learning tasks is provided. The method includes generating, by at least one processor device operatively coupled to a memory, one or more state partitioning candidates corresponding to a plurality of states associated with a partially observable Markov decision process (POMDP) model, determining, by the at least one processor, that a given state partitioning candidate of the one or more state partitioning candidates satisfies a merge condition based on a state transition matrix for the given state partitioning candidate, and performing, by the at least one processor, a machine learning task based on the POMDP model with merged states using the given state partitioning candidate.

In accordance with another embodiment of the present invention, a system for reducing computational costs to perform machine learning tasks is provided. The system includes a memory device for storing program instructions and at least one processor device operatively coupled to the memory device. The at least one processor device is configured to execute program instructions stored on the memory device to generate one or more state partitioning candidates corresponding to a plurality of states associated with a partially observable Markov decision process (POMDP) model, determine that a given state partitioning candidate of the one or more state partitioning candidates satisfies a merge condition based on a state transition matrix for the given state partitioning candidate, and perform a machine learning task based on the POMDP model with merged states using the given state partitioning candidate.

In accordance with yet another embodiment of the present invention, a computer program product is provided. The computer program product includes a non-transitory computer readable storage medium having program instructions embodied therewith. The program instructions are executable by a computer to cause the computer to perform a method for reducing computational costs for machine learning tasks using partially observable Markov decision processes (POMDP) models. The method performed by the computer includes generating one or more state partitioning candidates corresponding to a plurality of states associated with a partially observable Markov decision process (POMDP) model, determining that a given state partitioning candidate of the one or more state partitioning candidates satisfies a merge condition based on a state transition matrix for the given state partitioning candidate, and performing a machine learning task based on the POMDP model with merged states using the given state partitioning candidate.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a block diagram of a processing system in accordance with an embodiment of the present invention;

FIG. 2 is a block diagram showing an illustrative cloud computing environment having one or more cloud computing nodes with which local computing devices used by cloud consumers communicate in accordance with an embodiment;

FIG. 3 is a block diagram showing a set of functional abstraction layers provided by a cloud computing environment in accordance with one embodiment;

FIG. 4 is a diagram showing an exemplary problem setting, in accordance with an embodiment of the present invention;

FIG. 5 is a block/flow diagram showing a system/method for improving machine learning performed by a computer system by reducing states associated with a partially observable Markov decision process (POMDP) model, in accordance with an embodiment of the present invention;

FIG. 6 depicts diagrams illustrating examples of state transitions, in accordance with an embodiment of the present invention;

FIG. 7 is a diagram showing an illustrative implementation of the system/method of FIG. 5, in accordance with an embodiment of the present invention;

FIG. 8 is a diagram showing an exemplary use case for implementing the system/method of FIG. 5, in accordance with an embodiment of the present invention; and

FIG. 9 is a diagram illustrating an example of a machine learning task that can implement the system/method of FIG. 5, in accordance with an embodiment of the present invention.

### DETAILED DESCRIPTION

Markov decision process (MDP) models are used to model decision making processes in situations where outcomes are a combination of random and under the control of a decision maker. MDP models can be used to study a wide range of optimizations problems that can be solved using machine learning (e.g., reinforcement learning). The goal of reinforcement learning using MDP models is to train an artificial intelligence agent to select reward maximizing or cost minimizing actions taken from one state to another state in its environment.

The embodiments described herein reduce computational costs for machine learning tasks (e.g., reinforcement learning tasks), such as those that use partially observable Markov decision process (POMDP) models. POMDP models can be used to model decision making processes (e.g., reinforcement learning processes) where it is assumed that system dynamics are determined by an MDP, but the underlying state cannot be directly observed. Instead, a POMDP model maintains a probability distribution over all possible states based on a set of observations and observation probabilities and the underlying MDP. POMDPs are often computationally intractable to solve, so solutions for POMPDs can be approximated or estimated utilizing computer-implemented methods.

For example, the embodiments described herein can reduce computational costs for selecting actions to take based on a policy. A policy refers to a function that describes how to select actions in each state (e.g., belief), and can be used to maximize a total discounted reward in a POMDP model. That is, the policy is a mapping from a state to an action. In real-world problems where parameters can be unknown, model parameters used to discover a POMDP policy need to be learned from data by using one or more statistical models. The one or more statistical models can include a non-parametric model such as, e.g., an infinite Hidden Markov Model (iHMM). An iHMM is a model for time-series data that extends HMMs with an infinite number of hidden states. However, the representation of states in a POMDP policy search can be redundant when the model parameters, including the number of states, are estimated based on non-parametric models (e.g., iHMMs).

To address these and other concerns, the embodiments described reduce computational costs for machine learning tasks for training an artificial intelligence agent. For example, the embodiments described herein can correctly merge redundant states of a POMDP model used to perform a machine learning task, which can reduce computational complexity associated with performing the machine learning task (e.g., discovering POMDP policies).

The embodiments described herein can be applied to a wide variety of real-world machine learning (e.g., reinforcement learning) tasks to reduce computational complexity and costs associated with the performance of the machine learning tasks. Examples of such machine learning tasks include, but are not limited to, dialog control, structural inspection, elevator control, active vision, robotic decision-making processes (e.g., robotic navigation), machine maintenance, patient management, collision avoidance, spoken dialogue systems, planning under uncertainty, etc.

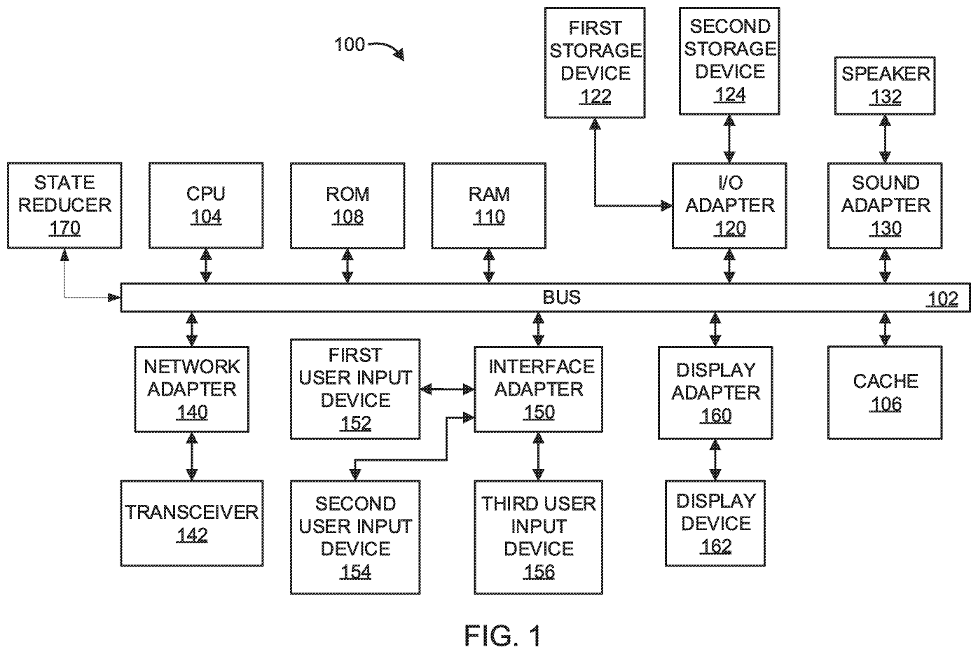

Referring now to the drawings in which like numerals represent the same or similar elements and initially to FIG. 1, an exemplary processing system 100 to which the present invention may be applied is shown in accordance with one embodiment. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154, and 156 can be the same type of user input device or different types of user input devices. The user input devices 152, 154, and 156 are used to input and output information to and from system 100.

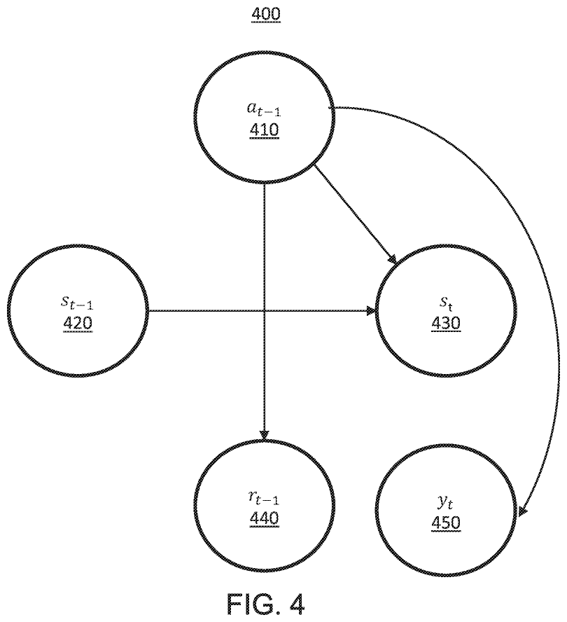

State reducer 170 may be operatively coupled to system bus 102. State reducer 170 is configured to perform one or more of the operations described below with reference to FIGS. 4-8. State reducer 170 can be implemented as a standalone special purpose hardware device, or may be implemented as software stored on a storage device. In the embodiment in which state reducer 170 is software-implemented, although the anomaly detector is shown as a separate component of the computer system 100, state reducer 170 can be stored on, e.g., the first storage device 122 and/or the second storage device 129. Alternatively, state reducer 170 can be stored on a separate storage device (not shown).

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

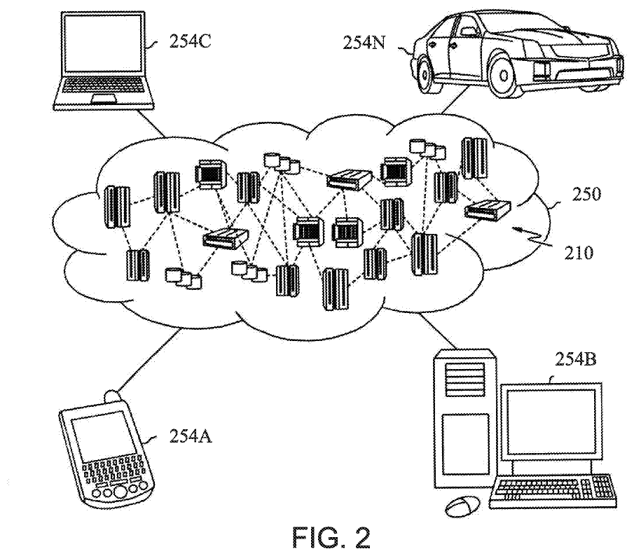

Referring now to FIG. 2, illustrative cloud computing environment 250 is depicted. As shown, cloud computing environment 250 includes one or more cloud computing nodes 210 with which local computing devices used by cloud consumers, such as, for example, personal digital assistant (PDA) or cellular telephone 254A, desktop computer 254B, laptop computer 254C, and/or automobile computer system 254N may communicate. Nodes 210 may communicate with one another. They may be grouped (not shown) physically or virtually, in one or more networks, such as Private, Community, Public, or Hybrid clouds as described hereinabove, or a combination thereof. This allows cloud computing environment 150 to offer infrastructure, platforms and/or software as services for which a cloud consumer does not need to maintain resources on a local computing device. It is understood that the types of computing devices 254A-N shown in FIG. 2 are intended to be illustrative only and that computing nodes 210 and cloud computing environment 250 can communicate with any type of computerized device over any type of network and/or network addressable connection (e.g., using a web browser).

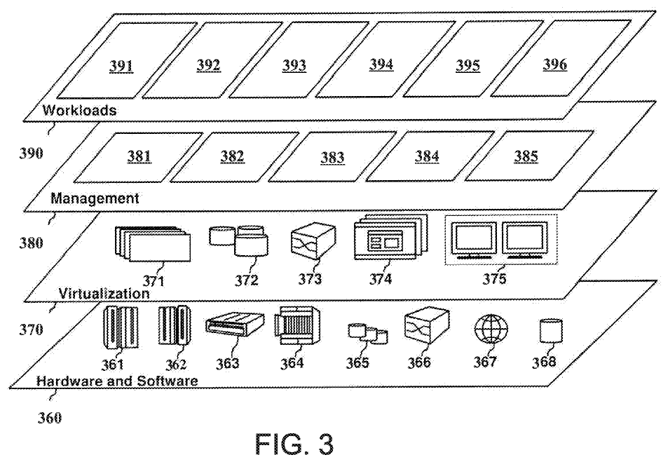

Referring now to FIG. 3, a set of functional abstraction layers provided by cloud computing environment 250 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 360 includes hardware and software components. Examples of hardware components include: mainframes 361; RISC (Reduced Instruction Set Computer) architecture based servers 362; servers 363; blade servers 364; storage devices 365; and networks and networking components 366. In some embodiments, software components include network application server software 367 and database software 368.

Virtualization layer 370 provides an abstraction layer from which the following examples of virtual entities may be provided: virtual servers 371; virtual storage 372; virtual networks 373, including virtual private networks; virtual applications and operating systems 374; and virtual clients 375.

In one example, management layer 380 may provide the functions described below. Resource provisioning 381 provides dynamic procurement of computing resources and other resources that are utilized to perform tasks within the cloud computing environment. Metering and Pricing 382 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 383 provides access to the cloud computing environment for consumers and system administrators. Service level management 384 provides cloud computing resource allocation and management such that required service levels are met. Service Level Agreement (SLA) planning and fulfillment 385 provide pre-arrangement for, and procurement of, cloud computing resources for which a future requirement is anticipated in accordance with an SLA.

Workloads layer 390 provides examples of functionality for which the cloud computing environment may be utilized. Examples of workloads and functions which may be provided from this layer include: mapping and navigation 391; software development and lifecycle management 392; virtual classroom education delivery 393; data analytics processing 394; transaction processing 395; and state reduction 396.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Parameters in a POMDP model based on, e.g., iHMM, can be estimated given time-series data. The time-series data can include reward data (R=r_{1:T}), observation data (Y=y_{1:T}), and action data (A=a_{1:T}). With respect to the embodiments described herein, it is assumed that there are K states (“s”) and a plurality of parameters. The plurality of parameters can include a state transition matrix, Pₜ, defined as p (s|s, a), an emission distribution, Φ, defined as p (y|s, a), and a reward distribution, ψ, defined as p(r|s, a).

Referring now to FIG. 4, a diagram 400 is provided illustrating an exemplary problem setting for estimating parameters. The diagram 400 is shown as a directed graph including a plurality of nodes 410-450. Node 410 represents an action at time t-1 (aₜ₋₁), node 420 represents a state at time t-1 (sₜ₋₁), node 430 represents a state at time t (sₜ), node 440 represents a reward at time t-1 (rₜ₋₁), and node 450 represents an observation at time t (yₜ). As shown, node 410 is connected to nodes 430-450, and node 420 is connected to node 430.

In the problem setting of FIG. 4, state representation as a result of the estimation can be redundant, as a single state can be represented with multiple states. The computational complexity of searching for a policy that maximizes a total discounted reward in the POMDP model can increase as a function of the redundancy of states.

To reduce the number of states in order to improve processing performed by a computer system during machine learning tasks, as will be described in further detail below, parameters can be used to determine whether states in the estimation results are the same, and states in the estimation results determined to be the same can be merged. Accordingly, computational complexity of searching for the policy can be reduced.

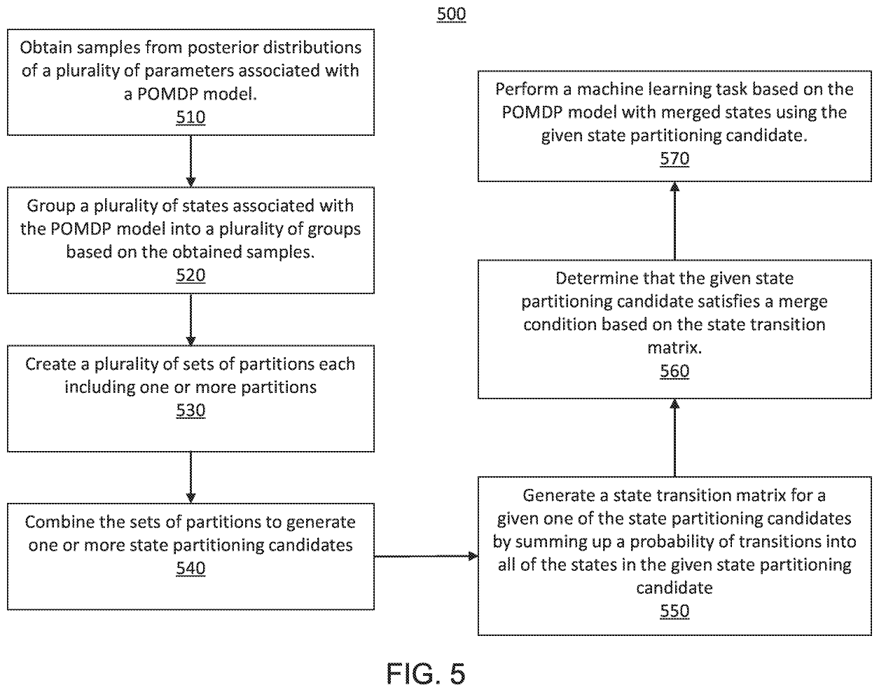

Referring to FIG. 5, a block/flow diagram 500 is provided illustrating a system/method for reducing computational costs for machine learning tasks using partially observable Markov decision processes (POMDP) models, in accordance with an embodiment of the present invention.

At block 510, samples from posterior distributions of a plurality of parameters associated with a POMDP model are obtained. The plurality of parameters can include a state transition matrix, Pₜ, an emission distribution, Φ, and a reward distribution, ψ. In one embodiment, the samples can be obtained by employing a Markov Chain Monte Carlo (MCMC) method.

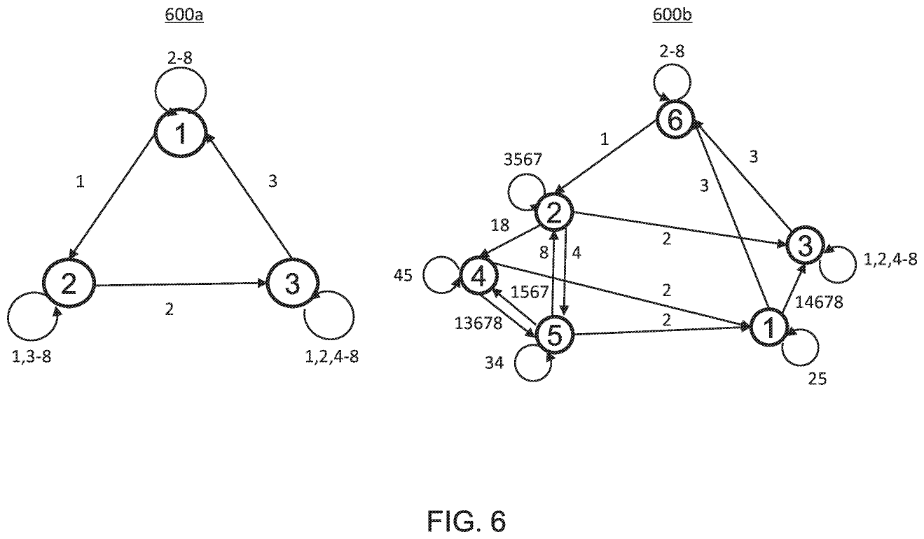

The sampling performed at block 510 can generate redundant state representations. This can be due at least in part to adding actions to, e.g., iHMM. For example, without action, transitions into multiple states representing the same state are merged into one state as the sampling proceeds and samples converges to the posterior distributions of each row of Pₜ (Dirichlet distribution) because of the property of Dirichlet distribution. An illustration regarding how adding actions can generate redundant state representations will now be described with reference to FIG. 6.

Referring now to FIG. 6, for a (stochastic) policy task having (estimated) states s={1, 2, 3} and actions a={1, 2, 3, 4, 5, 6, 7, 8}, a diagram 600a is provided illustrating a true state transition and a diagram 600b is provided illustrating an estimation result of beam sampling. Diagrams 600a and 600b are depicted as directed graphs, where each node represents a state and each edge represents an action taken from a state.

As shown, when actions are added, a state transition distribution is defined for each (s, a) so a destination from each (s, a) is merged to one, but for each s, more than one destination can exist. For example, in diagram 600a, only one state transition destination exists for each state (e.g., state 2 transitions to state 3 if action 2 is taken). However, in diagram 600b, multiple state transition destinations can exist. For example, as shown, state 2 can transition to: (1) state 4 when action 1 or 8 is taken; (2) state 5 when action 4 is taken; or (3) state 2 when action 3, action 5, action 6 or action 7 is taken.

Referring back to FIG. 5, at block 520, a plurality of states associated with the POMDP model are grouped into a plurality of groups based on the samples obtained at block 510. The plurality of states can be estimated. Each of the plurality of groups includes one or more of the plurality of states having similar posterior distributions of the parameters (e.g., emission distribution and reward distribution). A variety of techniques can be used to determine which states have similar posterior distributions. For example, a judging method can be used, or a sample mean can be compared to a threshold. In one embodiment, the judging method can include a Kolmogrov-Smirnov test.

At block 530, a plurality of sets of partitions each including one or more partitions is created. Each of the plurality of sets of partitions corresponds to a respective one of the plurality of groups.

At block 540, the sets of partitions are combined to generate one or more state partitioning candidates. Each state partitioning candidate divides states of each group into a plurality of subgroups. The one or more state partitioning candidates can be enumerated based on a number of the subgroups corresponding to each state partitioning candidate (e.g., in ascending order).

At block 550, a state transition matrix for a given one of the state partitioning candidates is generated by summing up a probability of transitions into all of the states in the given state partitioning candidate.

At block 560, it is determined that the given state partitioning candidate satisfies a merge condition based on the state transition matrix for the given state partitioning candidate. In one embodiment, determining that the given state partitioning candidate satisfies the merge condition includes determining whether posterior distributions of the parameters are the same for all actions and states in each of the subgroups of the given state partitioning candidate. To determine whether the posterior distributions of the parameters are the same for all actions and states in the given subgroup, a judging method, such as, e.g., a Kolmogorov-Smirnov test can be used. Alternatively, to determine whether the posterior distributions of the parameters are the same for all actions and states in the given subgroup, a sample mean can be compared to a threshold.

At block 570, a machine learning task is performed based on the POMDP model with merged states using the given state partitioning candidate. In one embodiment, the machine learning task includes a reinforcement learning task. For example, an artificial intelligence agent can use the given state partitioning candidate to perform the machine learning task.

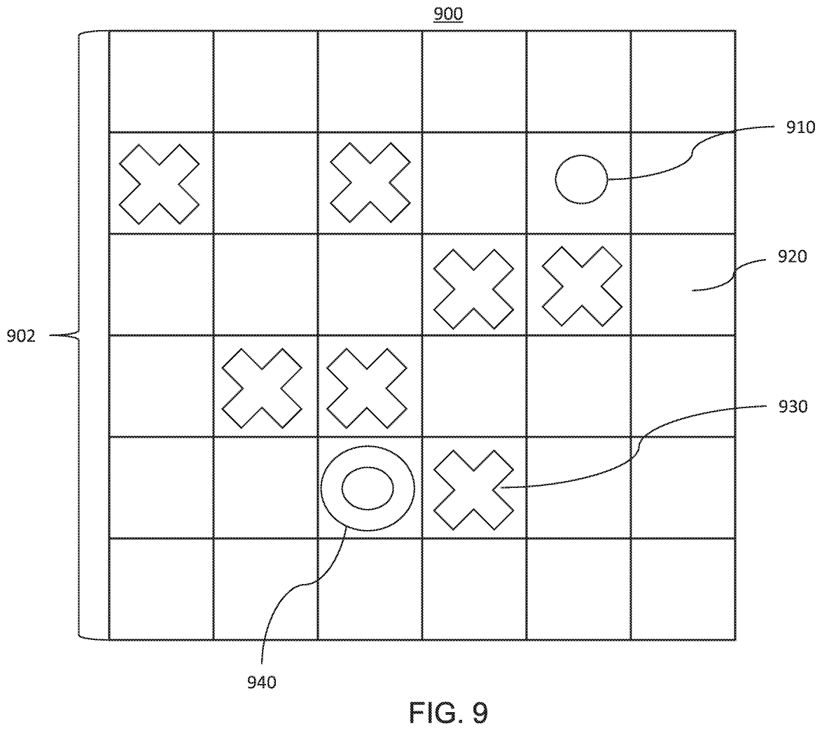

The given state partitioning candidate corresponds to a new representation of states, with each subgroup corresponding to a “new state.” Since the number of subgroups of the state partitioning candidate is less than the number of states due to the merging of states, computational complexity and cost for the artificial intelligence agent to perform the machine learning task based on the POMDP model is reduced, thereby improving processing performed by a computer system implementing the artificial intelligence agent. An illustrative example of a machine learning task that can be improved in accordance with the embodiments described herein will be described below with reference to FIG. 9.

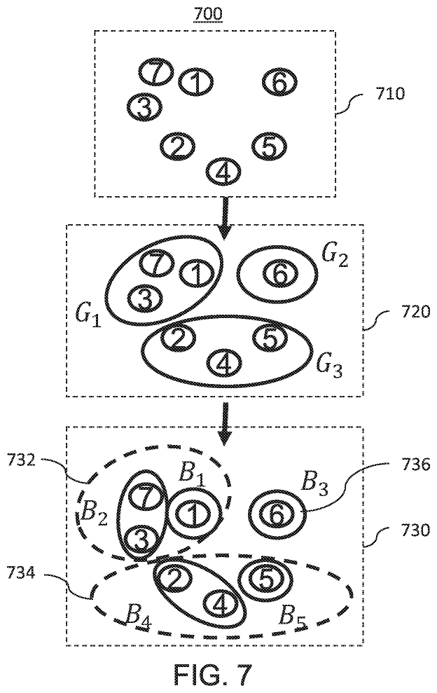

Referring now to FIG. 7, a diagram 700 is provided illustrating an illustrative example of the process performed by the system/method of FIG. 5 for reducing computational costs for machine learning tasks using partially observable Markov decision processes (POMDP) models.

A plurality of states 710 are associated with a (stochastic) policy task are obtained (e.g., estimated). In this illustrative example, K=7 states are estimated. However, the number of states should not be considered limiting. The state representation can be redundant, such that multiple states can represent the same state.

The plurality of states 710 are grouped into a set of groups 720, including G₁, G₂ and G₃. Thus, as shown, the set of groups 720 can be defined as G={G₁, G₂, G₃}, where G₁={1, 3, 7}, G₂={6} and G₁={2, 4, 5}. As described above, the plurality of states 710 can be merged into their respective groups based on similarity of posterior distributions of Φ (emission distribution), and a reward distribution, ψ (reward distribution).

Each group Gᵢ can be partitioned to create a set of partitions including one or more partitions, and the partition(s) can be enumerated based on the number of subgroups (e.g., in ascending order). For example, the set of partitions of G₁={1, 3, 7}, {{1, 3}, {7}}, {{1, 7}, {3}}, {{3,7}, {1}}, {{1}, {3}, {7}}, the set of partitions G₂={6}, and the set of partitions G₃={2, 4, 5}, {{2, 4}, {5}}, {{2, 5}, {4}}, {{4, 5}, {2}}, {{2}, {4}, {5}}. Accordingly, if the number of partitions of in the set of partitions corresponding to Gᵢ is defined as gᵢ, then g₁=5, g₂=1 and g₃=5.

The partitions of G₁, G₂ and G₃ can be combined to obtain 25 (5×1×5) a set of state partitioning candidates of the 7 states as follows: {{1, 3, 7},{6}}, {2, 4, 5}}, {{1, 3}, {7}, {6}, {2,4,5}}, . . . , {{1}, {3}, {7}, {6}, {2}, {4}, {5}}.

Now, suppose that for a given state partitioning candidate B 730, including partitions B₁={1}, B₂={3, 7}, B₃={6}, B₄={2,4}, the states in each B of B are merged into subgroups. The subgroups include subgroup 732 including B₁ and B₂, subgroup 734 including B₄ and B₅, and subgroup 736 including B₃.

A new state transition matrix p(B\s,a) can be generated by summing up the probability in Pₜ (state transition matrix) of transitions into states in B. It is determined whether the posterior distributions of the parameters of the states in each of the subgroups 732-736 are the same for all actions a. For example, it is determined whether the posterior distributions of the parameters of p(B\s₃,a), p(B\s₇,a) are the same for all a, and whether the posterior distributions of the parameters of p(B\s₂,a) and p(B\s₄,a) are the same for all a.

If this merge condition is satisfied, then the given state partitioning candidate B 730 is output as the merge result. Accordingly, in this illustrative example, redundant ones of the 7 estimated states are merged into 5 states: B₁, B₂, B₃, B₄ and B₅, thereby reducing computational complexity associated with the POMDP model and improving machine learning performed by a computer system.

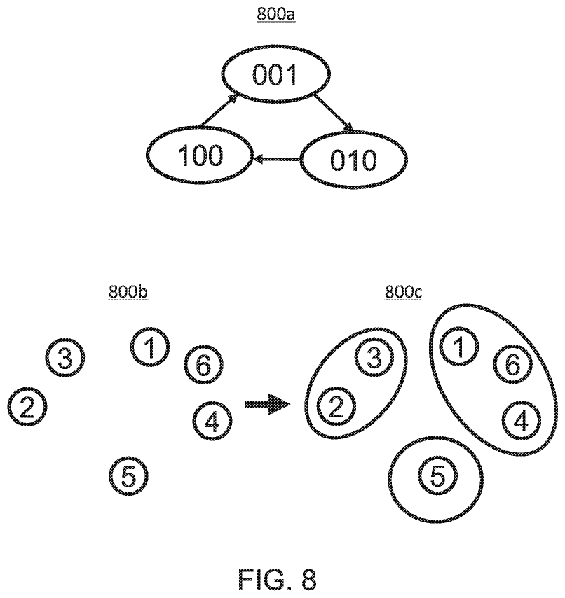

Referring now to FIG. 8, diagrams 800a and 800b are provided showing an exemplary use case for implementing the system/method of FIG. 5, in accordance with an embodiment of the present invention. In this illustrative example, the set of states S={001,010,100} and the set of actions A={001,010,011, . . . , 100}. If the state and action coincide, the states transition as depicted in diagram 800a and the reward r=1.

As shown, diagram 800a is depicted as a directed graph, where each node represents a state and each edge represents an action taken from a state. If the state and action do not coincide, the state remains the same and the reward r=0. In this illustrative example, the observation y˜ [symbol] (μ,1), where μ ∈ {−1,0,1} according to the state, the length of the time-series data T=10000, and the number of samples obtained N=3000 (e.g., using an MCM method).

As further shown, diagram 800b represents an original representation of states resulting from sampling. It is assumed that the original representation of the states is redundant since multiple states represent the same state.

As further shown, diagram 800c depicts a new representation of the states after merging is performed in accordance with the embodiments described herein. In this illustrative example, states 2 and 3 are merged together and states 1, 6 and 4 are merged together, thereby reducing the number of states from 6 to 3.

In this illustrative embodiment, the number of computations performed by the merging process described herein is reduced as compared to other merging processes. For example, the number of partitions of states using the procedure described herein is 10, whereas the number of partitions of states using other procedures can be over 300.

POMDP models can be used in the implementation of reinforcement learning. As described above, the goal of reinforcement learning is to train an artificial intelligence agent to select reward maximizing or cost minimizing actions taken from one state to another state in its environment. By reducing states in a POMDP model in accordance with the embodiments described herein, an artificial intelligence agent can undergo reinforcement learning using the POMDP model using fewer computational resources, thereby increasing the overall efficiency of the reinforcement learning process.

Referring to FIG. 9, a diagram 900 is provided illustrating an example of a machine learning task, autonomous robotic navigation, that can implement the embodiments described herein for reducing computational costs to perform the machine learning task.

As shown, a robot 910 is located within in an environment 902. As shown, the environment 902 is modeled as an 6 x 6 grid that includes a plurality of passable spaces 920, and a plurality of impassable spaces 930. In this illustrative example, the robot 910 can only move horizontally or vertically, and the goal of the robot 910 is to get to the space 940 by selecting navigation actions that maximize rewards or minimize costs.

A state of the robot 910 can include its position and orientation in space (e.g., three-dimensional space). If a state of the robot 910 can be fully observed in the environment 902 (e.g., the position and orientation are both fully observable), then a MDP model can be used to discover a MDP policy that maps states to navigation actions performed by the robot 910 as to maximize future rewards.

However, if a state of the robot 910 cannot be fully observed in the environment 902 (e.g., due to robotic sensor issues, only one of position and orientation being fully observable, or other problems that can affect the ability of the robot 910 to fully observe its state), a POMDP model can be used. Due to the state of the robot 910 not being fully observable in the POMDP context, the state of the robot 910 can be modeled as a probability distribution over all possible states of the robot 910, which is referred to as a belief. The set of all beliefs form the belief space of the robot 910. The goal is to discover a POMDP policy that maps states corresponding to beliefs of the belief space to actions performed by the robot 910 as to maximize future rewards.

The size or dimensionality of the belief space is proportional to the number of possible number of states of the robot 910. If the environment 902 is a three-dimensional environment, the size of the belief space can grow exponentially due to the potentially vast possible number of states that the robot 910 can realize within the environment 902, which can include at least some redundant states. The embodiments described herein above with reference to FIGS. 5-7 can be applied to merge redundant ones of the states in order to reduce the number of states corresponding to the robot 910 in the environment 902. As one having ordinary skill in the art would appreciate, merging the redundant states in accordance with the embodiments described herein can improve the ability of the robot 910 to perform its machine learning task (e.g., reinforcement learning task) of navigating within the environment 902 to arrive at space 940. For example, computational complexity and costs can be reduced.

The illustrative embodiment described with reference to FIG. 9 is purely exemplary. As described above, the embodiments described herein can be applied to a wide variety of real-world machine learning (e.g., reinforcement learning) tasks to reduce computational complexity and costs associated with the performance of other machine learning tasks that can be implemented using POMDP models. Examples of such other machine learning tasks include, but are not limited to, dialog control, structural inspection, elevator control, active vision, machine maintenance, patient management, collision avoidance, spoken dialogue systems, planning under uncertainty, etc.

Having described preferred embodiments of a system and method for reducing computational costs to perform machine learning tasks (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for reducing computational costs to perform machine learning tasks, comprising:
generating, by at least one processor device operatively coupled to a memory, one or more state partitioning candidates corresponding to a plurality of states associated with the a partially observable Markov decision process (POMDP) model;
determining, by the at least one processor device, that a given state partitioning candidate of the one or more state partitioning candidates satisfies a merge condition based on a state transition matrix for the given state partitioning candidate; and
performing, by the at least one processor device, a machine learning task based on the POMDP model with merged states using the given state partitioning candidate.

2. The method of claim 1, wherein the parameters include an emission distribution and a reward distribution, and wherein the one or more states of a given one of the plurality of groups have similar posterior distributions of the emission distribution and the reward distribution.

3. The method of claim 1, wherein the samples are obtained by employing a Markov Chain Monte Carlo (MCMC) method.

4. The method of claim 1, further comprising:
obtaining, by the at least one processor device, samples from posterior distributions of parameters associated with a partially observable Markov decision process (POMDP) model;
grouping, by the at least one processor device, the plurality of states into a plurality of groups based on the obtained samples, each of the plurality of groups including one or more of the plurality of states having similar posterior distributions of the parameters;
creating, by the at least one processor device, a plurality of sets of partitions each corresponding to a respective one of the plurality of groups and each including one or more partitions; and
combining, by the at least one processor device, the sets of partitions to generate the one or more state partitioning candidates.

5. The method of claim 1, wherein the one or more state partitioning candidates each include a plurality of subgroups.

6. The method of claim 5, further comprising enumerating, by the at least one processor device, the one or more state partitioning candidates based on a number of the subgroups corresponding to each state partitioning candidate.

7. The method of claim 6, wherein the one or more state partitioning candidates are enumerated in ascending order of the number of subgroups corresponding to each state partitioning candidate.

8. The method of claim 5, further comprising generating, by the at least one processor device, the state transition matrix for the given state partitioning candidate by summing up a probability of transitions into all of the states of the given state partitioning candidate.

9. The method of claim 8, wherein determining whether the given state partitioning candidate satisfies the merge condition includes determining whether the posterior distributions of the parameters are the same for all actions and states in each of the subgroups of the given state partitioning candidate.

10. The method of claim 9, wherein the given state partitioning candidate is determined to satisfy the merge condition by using a Kolmogorov-Smirnov test or comparing a sample mean to a threshold.

11. A system for reducing computational costs for machine learning tasks using partially observable Markov decision processes (POMDP) models, comprising:
a memory device for storing program instructions; and
at least one processor device operatively coupled to the memory device and configured to execute program code stored on the memory device to:
generate one or more state partitioning candidates corresponding to a plurality of states associated with a partially observable Markov decision process (POMDP) model;
determine that a given state partitioning candidate of the one or more state partitioning candidates satisfies a merge condition based on a state transition matrix for the given state partitioning candidate; and
perform a machine learning task based on the POMDP model with merged states using the given state partitioning candidate.

12. The system of claim 11, wherein the parameters include an emission distribution and a reward distribution, and wherein the one or more states of a given one of the plurality of groups have similar posterior distributions of the emission distribution and the reward distribution.

13. The system of claim 11, wherein the samples are obtained by employing a Markov Chain Monte Carlo (MCMC) method.

14. The system of claim 11, wherein the at least one processor device is configured to generate the one or more state partitioning candidates by:
obtaining samples from posterior distributions of parameters associated with the POMDP model;
grouping the plurality of states into a plurality of groups based on the obtained samples, each of the plurality of groups including one or more of the plurality of states having similar posterior distributions of the parameters;
creating a plurality of sets of partitions each corresponding to a respective one of the plurality of groups and each including one or more partitions; and
combining the sets of partitions to generate the one or more state partitioning candidates.

15. The system of claim 11, wherein each state partitioning candidate includes a plurality of subgroups, and wherein the at least one processor device is further configured to execute program code stored on the memory device to enumerate the one or more state partitioning candidates based on a number of the subgroups corresponding to each state partitioning candidate.

16. The system of claim 15, wherein the one or more state partitioning candidates are enumerated in ascending order of the number of subgroups corresponding to each state partitioning candidate.

17. The system of claim 15, wherein the at least one processor device is further configured to execute program code stored on the memory device to generate the state transition matrix for the given state partitioning candidate by summing up a probability of transitions into all of the states in the given state partitioning candidate.

18. The system of claim 17, wherein the at least one processor device is further configured to determine whether the given state partitioning candidate satisfies the merge condition by determining whether the posterior distributions of the parameters are the same for all actions and states in each of the subgroups of the given state partitioning candidate.

19. The system of claim 18, wherein the at least one processor device is further configured to execute program instructions stored on the memory device to determine whether the given state partitioning candidate satisfies the merge condition by using a Kolmogorov-Smirnov test or comparing a sample mean to a threshold.

20. A computer program product comprising a non-transitory computer readable storage medium having program instructions embodied therewith, the program instructions executable by a computer to cause the computer to perform a method for reducing computational costs to perform machine learning tasks, the method performed by the computer comprising:
generating one or more state partitioning candidates corresponding to a plurality of states associated with a partially observable Markov decision process (POMDP) model;
determining that a given state partitioning candidate of the one or more state partitioning candidates satisfies a merge condition based on a state transition matrix for the given state partitioning candidate; and
performing a machine learning task based on the POMDP model with merged states using the given state partitioning candidate.
